(19) United States
(12) Patent Application Publication
(10) Pub. No.: US 2023/0406357 A1
(43) Pub. Date: Dec. 21, 2023

(54) AUTONOMOUS DRIVING CONTROL DEVICE AND AUTONOMOUS DRIVING CONTROL METHOD

(71) Applicant: DENSO CORPORATION, Kariya-city (JP)

(72) Inventor: Hideaki MISAWA, Kariya-city (JP)

(21) Appl. No.: 18/459,981

(22) Filed: Sep. 1, 2023

Related U.S. Application Data
(63) Continuation of application No. PCT/JP2022/008072, filed on Feb. 25, 2022.

(30) Foreign Application Priority Data
Mar. 5, 2021 (JP) 2021-035460

(51) Int. Cl. B60W 60/00; B60W 50/02; B60W 50/14

(52) U.S. Cl. CPC B60W 60/00186; B60W 50/0205; B60W 50/14; B60W 2050/146

(57) ABSTRACT

In an autonomous driving control device, a collection unit collects from an autonomous driving vehicle, driving data including own-state quantities representing a state of the autonomous driving vehicle. A determination unit compares a driving trajectory under evaluation for the autonomous driving vehicle with a reference driving trajectory acquired from a driving trajectory model representing specific values of the own-state quantities in a time series, and determines an abnormality level indicating a degree of deviation between the driving trajectory under evaluation and the reference driving trajectory. Upon the determination unit determining that the abnormality level indicates presence of an abnormality, a presentation unit presents to an operator the image data, based on which the abnormality level was determined to indicate the presence of an abnormality, and receive a confirmation of presence or absence of an abnormality and its factor as input from the operator. An output unit outputs report data.

### CROSS-REFERENCE TO RELATED APPLICATION

This application is a continuation application of International Application No. PCT/JP2022/008072 filed Feb. 25, 2022 which designated the U.S. and claims priority to Japanese Patent Application No. 2021-035460 filed with the Japan Patent Office on Mar. 5, 2021, the contents of each of which are incorporated herein by reference.

### BACKGROUND

### Technical Field

The present disclosure relates to an autonomous driving control device and an autonomous driving control method.

### Related Art

In an autonomous driving system, a driver may not be present. Thus, it is necessary to monitor on behalf of the driver whether traveling in an autonomous driving section of a road has been properly performed by an autonomous driving control program.

For example, an information processing device is known that generates information that triggers improvement of control programs for autonomous driving. This known information processing device performs a data generation process based on probe information from autonomous vehicles and road map data, to generate driving risk data including the presence or absence of abnormal driving in driving sections where autonomous driving has been performed and presence or absence or values of features that may cause abnormal driving, and a modelling process based on a plurality of pieces of generated driving risk data, to generate a risk determination model that includes the occurrence probability of abnormal driving for the presence or absence or for each of values of the features. These features include only external factors that are road side events.

### BRIEF DESCRIPTION OF THE DRAWINGS

In the accompanying drawings:

FIG. 1 is a schematic of an example configuration of an autonomous driving system according to a first embodiment;

FIG. 2 is a functional block diagram of an on-board device and an autonomous driving control device according to the first embodiment;

FIG. 3 is an illustration of a process of calculating a representative value of a planning result according to the first embodiment;

FIG. 4 is an example of a comparison between the speed in autonomous driving and the speed in manual driving;

FIG. 5 is an illustration of an abnormality level determination process according to the first embodiment;

FIG. 6 is an illustration of another abnormality level determination process according to the first embodiment;

FIG. 7 is an illustration of the overall abnormality level determination process implemented by the autonomous driving control device according to the first embodiment;

FIG. 8 is a flowchart of an example of the abnormality level determination process implemented by the autonomous driving control program according to the first embodiment;

FIG. 9 is a flowchart of an example of a report output process implemented by the autonomous driving control program according to the first embodiment;

FIG. 10 is an illustration of a determination-by-operator process according to the first embodiment;

FIG. 11 is an illustration of another determination-by-operator process according to the first embodiment;

FIG. 12 is an illustration of yet another determination-by-operator process according to the first embodiment;

FIG. 13 is a functional block diagram of an on-board device and an autonomous driving control device according to a second embodiment;

FIG. 14 is an illustration of a clustering process according to the second embodiment;

FIG. 15 is an illustration of a determination-by-operator process according to the second embodiment;

FIG. 16 is an illustration of another determination-by-operator process according to the second embodiment;

FIG. 17 is a flowchart of an example of a learner generation process implemented by an autonomous driving control program according to the second embodiment; and

FIG. 18 is a flowchart of an example of an immediate notification process implemented by the autonomous driving control program according to the second embodiment.

### DESCRIPTION OF SPECIFIC EMBODIMENTS

In autonomous driving, the absence of obvious abnormal driving does not mean that there has been no abnormality in the autonomous driving control program. For example, if an autonomous driving vehicle is traveling closer to the left side of the lane than usual, it is not determined as abnormal driving in the above known information processing device as disclosed in JP 2017-146934 A, because only specific driving is determined to be abnormal. However, if this driving trajectory is caused by an unintended autonomous driving control program, it may be a cause of future accidents. If it is possible to detect driving that is not such an obvious abnormality but differs from planned or optimal driving of the autonomous driving vehicle (i.e., driving that is different from usual), it will, as desired, become possible to allow for early resolution of such an issue.

In view of the foregoing, it is desired to have a technique for controlling autonomous driving, capable of determining driving that is not obviously abnormal but deviates from planned or optimal driving in autonomous driving.

A first aspect of the present disclosure provides an autonomous driving control device includes: a collection unit configured to collect from an autonomous driving vehicle having a driving trajectory planned in advance, driving data including own-state quantities representing a state of the autonomous driving vehicle; a generation unit configured to generate a driving trajectory model representing specific values of the own-state quantities in a time series based on the driving data collected by the collection unit; a determination unit configured to compare a driving trajectory under evaluation for the autonomous driving vehicle with a reference driving trajectory acquired from the driving trajectory model generated by the generation unit, and determine an abnormality level indicating a degree of deviation between the driving trajectory under evaluation and the reference driving trajectory; a presentation unit configured to, upon the determination unit determining that the abnormality level indicates presence of an abnormality, present to an operator image data, based on which the abnormality level was determined to indicate the presence of an abnormality, and receive a confirmation of presence or absence of an abnormality and its factor as input from the operator; and an output unit configured to output report data including the confirmation of presence or absence of an abnormality and its factor that are received as input from the operator.

A second aspect of the present disclosure provides an autonomous driving control method including: collecting from an autonomous driving vehicle having a driving trajectory planned in advance, driving data including own-state quantities representing a state of the autonomous driving vehicle; generating a driving trajectory model representing specific values of the own-state quantities in a time series based on the collected driving data; comparing a driving trajectory under evaluation for the autonomous driving vehicle with a reference driving trajectory acquired from the generated driving trajectory model, and determining an abnormality level indicating a degree of deviation between the driving trajectory under evaluation and the reference driving trajectory; upon determining that the abnormality level indicates presence of an abnormality, presenting to an operator image data, based on which the abnormality level was determined to indicate the presence of an abnormality, and receiving a confirmation of presence or absence of an abnormality and its factor as input from the operator; and outputting report data including the confirmation of presence or absence of an abnormality and its factor that are received as input from the operator.

A third aspect of the present disclosure provides a non-transitory computer readable medium having stored thereon instructions executable by a computer to cause the computer to perform an autonomous driving control method, including: collecting from an autonomous driving vehicle having a driving trajectory planned in advance, driving data including own-state quantities representing a state of the autonomous driving vehicle; generating a driving trajectory model representing specific values of the own-state quantities in a time series based on the collected driving data; comparing a driving trajectory under evaluation for the autonomous driving vehicle with a reference driving trajectory acquired from the generated driving trajectory model, and determining an abnormality level indicating a degree of deviation between the driving trajectory under evaluation and the reference driving trajectory; upon determining that the abnormality level indicates presence of an abnormality, presenting to an operator image data, based on which the abnormality level was determined to indicate the presence of an abnormality, and receiving a confirmation of presence or absence of an abnormality and its factor as input from the operator; and outputting report data including the confirmation of presence or absence of an abnormality and its factor that are received as input from the operator.

The technique of this disclosure can provide, as an advantage, the capability of determining driving that is not obviously abnormal but deviates from planned or optimal driving in autonomous driving.

Hereinafter, exemplary embodiments of the present disclosure will be described in detail with reference to the accompanying drawings.

### First Embodiment

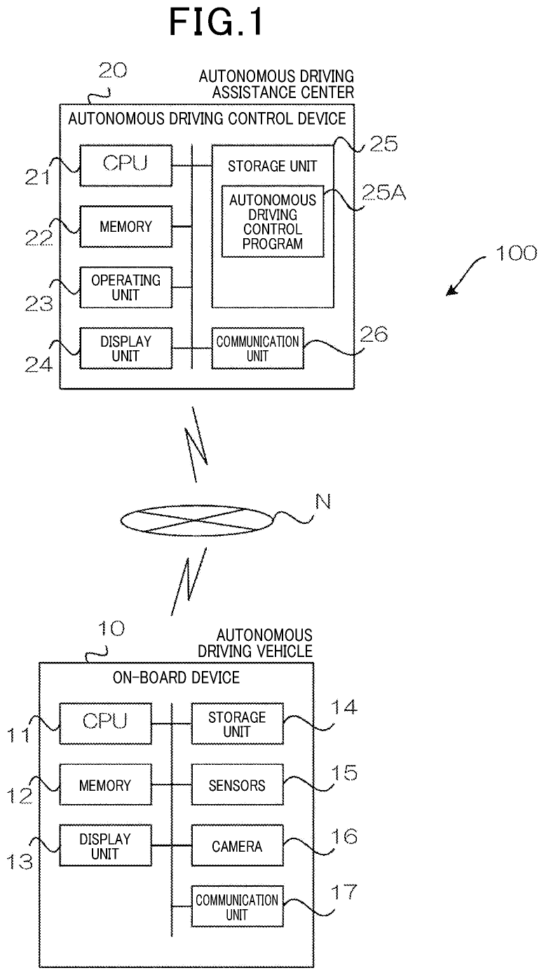

FIG. 1 illustrates an example of a configuration of an autonomous driving system 100 in accordance with a first embodiment.

As illustrated in FIG. 1, the autonomous driving system 100 according to the present embodiment includes an on-board device 10 mounted to an autonomous driving vehicle and an autonomous driving control device 20 installed in an autonomous driving assistance center.

The autonomous driving control device 20 provides remote assistance to autonomous driving vehicles within an area to be managed by the autonomous driving assistance center. In the present embodiment, although private automobiles will now be described as an example of the autonomous driving vehicles, the autonomous driving vehicles may also include other kinds of vehicles, such as trucks, buses, cabs or the like. The autonomous driving vehicles may further include manned vehicles in which a driver performs vehicle control or takes over vehicle control in case of an emergency. The autonomous driving vehicles may still further include vehicles in which steering is performed in part automatically.

The on-board device 10 and the autonomous driving control device 20 are communicatively connected via a network N. As an example, the Internet, a wide area network (WAN), etc. may be used as the network N.

An autonomous driving vehicle is a vehicle capable of autonomous driving without driver's operations under predefined conditions. The autonomous driving vehicle performs an overtaking or standby operation in response to occurrence of a certain abnormal event, such as on-road parking, traffic congestion, construction or the like, during travel. The autonomous driving vehicle is provided with driving assistance by the automated driving assistance center according to a situation, such as when an abnormality occurs.

The on-board device 10 has a function to generate a travel plan including a travel route to a destination, based on destination information such as an address or latitude and longitude, and a function to control autonomous driving of the own vehicle. The on-board device 10 includes a central processing unit (CPU) 11, a memory 12, a display unit 13, a storage unit 14, sensors 15, at least one camera 16, and a communication unit 17.

The CPU 11 is an example of a processor. The processor here refers to a processor in the broadest sense, and may be a general-purpose processor (e.g., CPU) or a specific-purpose processor (e.g., a graphics processing unit (GPU), an application specific integrated circuit (ASIC), a field programmable gate array (FPGA), a programmable logical device, or the like). The memory 12 is formed of a read only memory (ROM), a random access memory (RAM), or the like.

For example, a liquid crystal display (LCD), an organic electroluminescent (EL) display, or the like may be used for the display unit 13. The display unit 13 may have a touch panel integrated therein.

For example, a hard disk drive (HDD), a solid state drive (SSD), or a flash memory or the like may be used for the storage unit 14. The storage unit 14 stores a control program (not shown) for controlling autonomous driving.

The sensors 15 include various sensors to detect surroundings of the own vehicle. The sensors 15 include a millimeter wave radar that transmits probe waves to a predefined region outside the vehicle, and light detection and ranging/laser imaging detection and ranging (LIDAR) that scans at least a predefined region ahead of the vehicle. The sensors 15 may also include a global navigation satellite system (GNSS) receiver mounted to the own vehicle. This GNSS receiver is used to acquire information such as current location of the own vehicle, the current time and the like.

The at least one camera 16 captures images of a predefined region in a predefined direction of the own vehicle. Specifically, the at least one camera 16 is provided all around the own vehicle and captures images of all the surrounding regions of the own vehicle. Although a single camera 16 may be used, a plurality of cameras may be provided at a plurality of positions in order to acquire more information.

The communication unit 17 is a communication interface that connects to a network N, such as the Internet or a WAN, to communicate with the autonomous driving control device 20.

The on-board device 10 is connected to a driving device (not shown) necessary for autonomous driving, and controls this driving device to perform autonomous driving. This driving device includes, as an example, electrical power steering, electronically controlled brakes, electronically controlled throttle, etc.

The on-board device 10 performs autonomous driving by controlling driving, steering, and braking of the own vehicle so as to follow the travel plan of the own vehicle. There are various known methods of autonomous driving itself, and the present embodiment is not limited to any specific method.

The autonomous driving control device 20 monitors the vehicle state of the autonomous driving vehicle by regularly communicating with the on-board device 10 of the autonomous driving vehicle. As an example, a general-purpose computer device, such as a server computer, a personal computer (PC) or the like, may be used for the autonomous driving control device 20. The autonomous driving control device 20 includes a CPU 21, a memory 22, an operating unit 23, a display unit 24, a storage unit and a communication unit 26.

The CPU 21 is an example of a processor. As described above, the processor here refers to a processor in the broadest sense, and may be a general-purpose processor or a specific-purpose processor. The memory 22 is formed of a ROM, a RAM, or the like.

The operating unit 23 is configured as an interface for receiving operating inputs to the autonomous driving control device 20. For example, a liquid crystal display (LCD), an organic EL display, or the like may be used for the display unit 24. The display unit 24 may have a touch panel integrated therein.

For example, a HDD, an SSD, a flash memory, or the like may be used for the storage unit 25. The storage unit 25 stores an autonomous driving control program 25A according to the present embodiment. The autonomous driving control program 25A may, for example, be preinstalled in the autonomous driving control device 20. The autonomous driving control program 25A may be implemented by storing it in a non-volatile, non-transitory storage medium or distributing it via the network N and installing it in the autonomous driving control device 20 as appropriate. Examples of the non-transitory storage medium include a compact disc read only memory (CD-ROM), a magneto-optical disk, a HDD, a digital versatile disc read only memory (DVD-ROM), a flash memory, a memory card, and the like.

The communication unit 26 is a communication interface that connects to the network N, such as the Internet or a WAN, to communicate with the on-board device 10.

By the way, as described above, if it is possible to detect driving that is not an obvious abnormality but differs from planned or optimal driving of the autonomous driving vehicle (i.e., driving that is different from usual), it will, as desired, become possible to allow for early improvement of issues, such as malfunctions or the like in the autonomous driving control program.

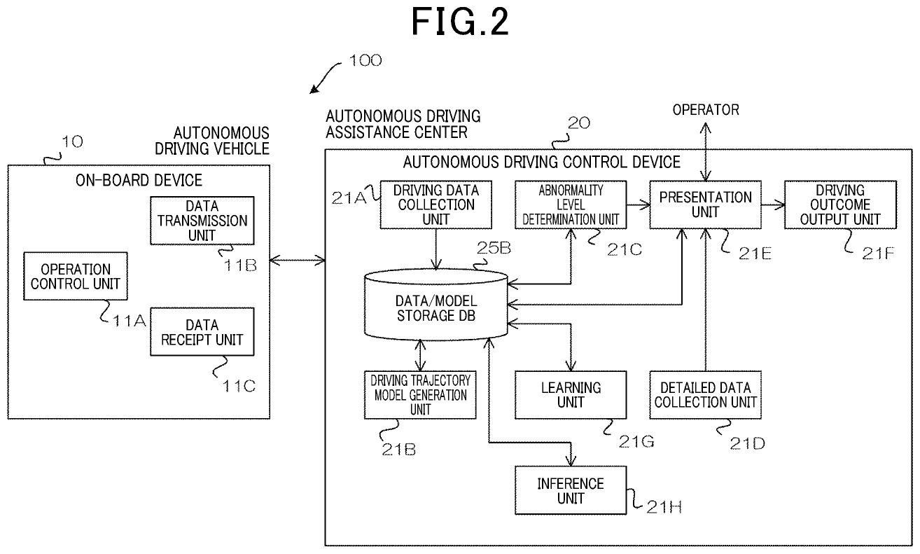

The CPU 11 of the on-board device 10 according to the present embodiment serves as the respective functional blocks illustrated in FIG. 2 by writing and executing the control program, which is stored in the storage unit 14, into the RAM. The CPU 21 of the autonomous driving control device 20 according to the present embodiment serves as the respective functional blocks illustrated in FIG. 2 by writing and executing the autonomous driving control program 25A, which is stored in the storage unit 25, into the RAM.

FIG. 2 is a block diagram illustrating an example of the functional configuration of the on-board device 10 and the autonomous driving control device 20 according to the first embodiment.

As illustrated in FIG. 2, the CPU 11 of the on-board device 10 of the present embodiment serves as an operation control unit 11A, a data transmission unit 11B, and a data receipt unit 11C.

The operation control unit 11A controls the operation of each of the sensors and the at least one camera 16. The operation control unit 11A stores time-series sensor data acquired from the sensors 15 in the storage unit 14 and time-series image data captured and acquired from the at least one camera 16 in the storage unit 14. The operation control unit 11A stores driving data, including own-state quantities, in the storage unit 14. The own-state quantities refer to a group of data representing the state of the own vehicle and includes, for example, vehicle behaviors, such as accelerating operation, steering operation, braking operation, an acceleration, a speed, a yaw rate, latitude and longitude (location information), time information, a vehicle angle, a target speed, a planning result, and the like. The planning result includes, for example, the state of the finite automaton of the middle level planner, candidate trajectories of the middle level planner and the low level planner. The operation control unit 11A also serves as a recognition unit that recognizes obstacles and other objects from the time-series image data acquired from the at least one camera 16, or from image data and sensor data.

The data transmission unit 11B controls transmission of driving data stored in the storage unit 14 to the autonomous driving control device 20 via the communication unit 17. The data transmission unit 11B controls transmission of image data, sensor data, and recognition results stored in the storage unit 14 to the autonomous driving control device 20 via the communication unit 17.

The data receipt unit 11C controls reception of instructions for transmission of driving data, image data, sensor data, and recognition results from the autonomous driving control device 20 via the communication unit 17.

As illustrated in FIG. 2, the CPU 21 of the autonomous driving control device according to the present embodiment serves as a driving data collection unit 21A, a driving trajectory model generation unit 21B, an abnormality level determination unit 21C, a detailed data collection unit 21D, a presentation unit 21E, a driving outcome output unit 21F, a learning unit 21G, and an inference unit 21H.

The driving data collection unit 21A regularly collects driving data including own-state quantities from the on-board device 10 of the autonomous driving vehicle, and stores the collected driving data in the data/model storage database (hereinafter referred to as “data/model storage DB”) 25B. Although this data/model storage DB is stored in the storage unit 25 as an example, it may be stored in an external storage device. The driving data collection unit 21A is an example of a collection unit.

The driving trajectory model generation unit 21B generates a driving trajectory model that represents specific values of own-state quantities in a time series based on the driving data stored in the data/model storage DB 25B. Specifically, the driving trajectory model generation unit 21B aggregates the own-state quantities (for example, vehicle behaviors, such as accelerating operation, steering operation, braking operation, an acceleration, a speed, a yaw rate and the like, latitude and longitude, time information, a vehicle angle, a target speed, a planning result, and the like) by time period (e.g., N months) or by segment (grid or node), and calculate a representative value (e.g., the mean, maximum, minimum, variance or the like) of the aggregated own-state quantities. For example, a geohash may be used for the grid. The representative value is calculated, for example, for the own-state quantities for each trip in the grid. This is one sample. For example, one trip is defined as a series of runs of one autonomous driving vehicle from ignition ON to ignition OFF. The trip may be one lap of a given course. The own-state quantities are subjected to a normalization process using a predetermined method (using, for example, the maximum, minimum, mean or variance for each behavior collected in advance) and a whitening process using principal component analysis. The driving trajectory model generation unit 21B is an example of a generation unit.

Specifically, the driving trajectory model generation unit 21B calculates, as the specific values of own-state quantities, offset values representing time series deviations of the candidate driving trajectory or actual driving trajectory from a reference trajectory planned in advance on a predefined digital map, and then aggregates the calculated offset values within a predetermined region (for example, a grid) to thereby calculate a representative value of the own-state quantities.

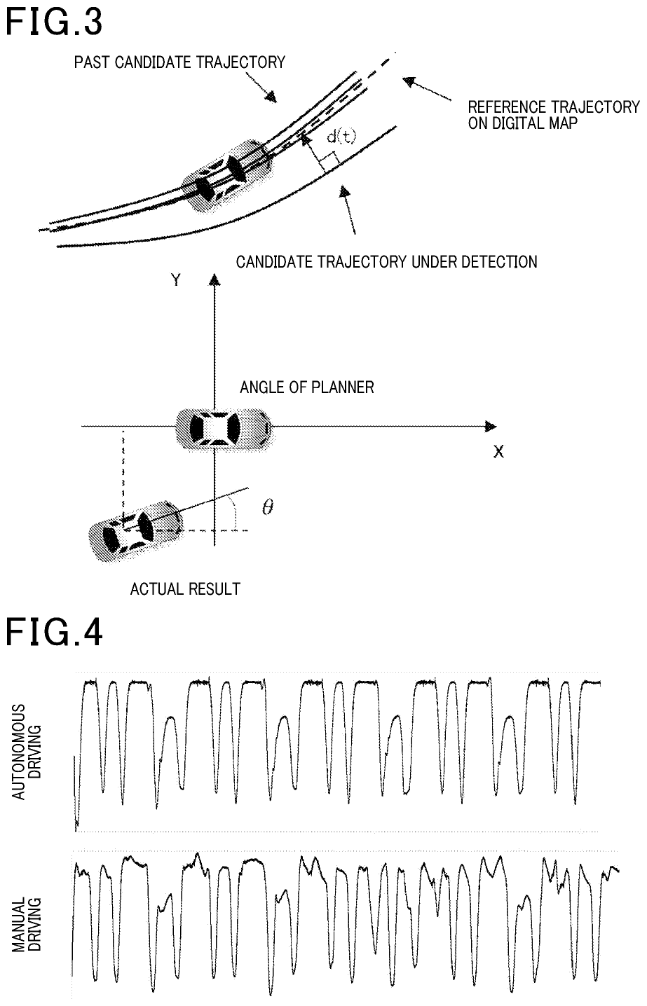

Referring to FIG. 3, the process of calculating the representative value of the planning results (i.e., the own-state quantities) will now be described in detail.

FIG. 3 is an illustration of the process of calculating the representative value of planning results according to the present embodiment.

As illustrated in FIG. 3, as an example of the process of calculating the representative value of the planning results, the reference trajectory on the digital map referenced by the planner (e.g., the center position of the lane of travel) and a past candidate trajectory, a candidate trajectory under detection (collectively, “candidate trajectory”) or an actual driving trajectory (actual trajectory) are used to acquire time-series offset value d(t) from the center position of the lane at respective times t. Based on the acquired offset values d(t), a representative value x_{d} is calculated by aggregating them within each grid. As a method for calculating the time-series offset values, distances between the reference trajectory and the candidate or actual trajectory in the grid may be calculated using the dynamic time warping (DTW) or other methods, and the calculated distances may be used. When angles are used, the deviation θ(t) between the actual vehicle angle and the planner angle may be calculated and used in the same way. The representative values x_{d} based on the own-state quantities acquired in this manner are arranged in a row and expressed as a feature vector x as expressed in the following. Here, T denotes the transposed matrix.

x=(x₁,x₂,x₃, . . . ,x_{d})^{T}

Since the planner plans a stable driving trajectory in the same environment, it is easier to extract unusual driving trajectories by modelling the planning result (own-state quantities) for each location.

The driving trajectory model generation unit 21B may generate the driving trajectory model for each autonomous driving vehicle or for each version of the program that controls autonomous driving of the autonomous driving vehicle. For example, even for autonomous driving vehicles of the same type, the vehicle body, the characteristics of the sensors or the like may differ between vehicles. In such a case, generating the driving trajectory model for each vehicle can make it easier to detect aging deterioration, malfunctions, or the like. In addition, generating the driving trajectory model for each program (software) version can make it easier to detect changes in driving trajectory caused by program modifications.

FIG. 4 is an example of a comparison between the speed in autonomous driving and the speed in manual driving. In FIG. 4, the horizontal axis indicates time and the vertical axis indicates speed.

As illustrated in FIG. 4, autonomous driving exhibits stable outputs with respect to the target speed, whereas manual driving exhibits large variations in output. This means that in autonomous driving, it is possible to readily extract driving that deviates from usual driving that matches the target speed.

The abnormality level determination unit 21C compares the reference driving trajectory acquired from the driving trajectory model generated by the driving trajectory model generation unit 21B and the driving trajectory under evaluation for the autonomous driving vehicle, and determines the abnormality level expressed as a degree of deviation between the reference driving trajectory and the driving trajectory under evaluation. The reference driving trajectory represents a driving trajectory to be used as a reference, and the driving trajectory under evaluation represents a driving trajectory to be evaluated. Specifically, the abnormality level determination unit 21C compares the feature quantities indicating the usual driving trajectory (reference driving trajectory) generated for each grid and the feature quantities indicating the driving trajectory under evaluation, and calculates a level of similarity between them. The feature quantities indicating the driving trajectory under evaluation may be, for example, feature quantities for one trip after the end of a day's driving, or feature quantities for the current driving.

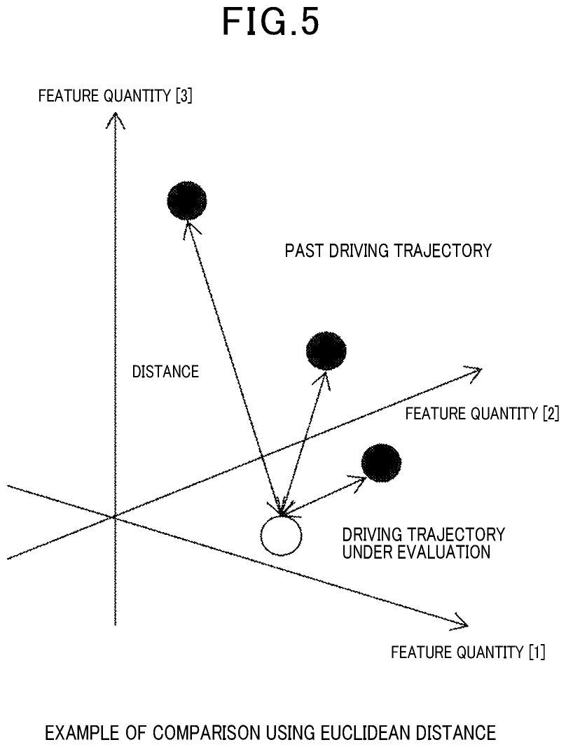

As an example, the Euclidean distance illustrated in FIG. 5 is used to compare the reference driving trajectory and the driving trajectory under evaluation. In this case, the smaller the Euclidean distance, the higher the level of similarity, i.e., the lower the abnormality level.

FIG. 5 is an illustration of an abnormality level determination process according to the present embodiment.

As illustrated in FIG. 5, the level of similarity between a set of past driving trajectories and the driving trajectory under evaluation is calculated using the Euclidean distance, and the abnormality level (i.e., degree of deviation) is determined. For example, the average distance in similarity generated beforehand between sets of driving trajectories with no abnormalities is set as a threshold value, and those exceeding the set threshold value are determined to have a high degree of deviation, that is, they are determined to be abnormal.

The method for calculating the level of similarity is not limited to use of the Euclidean distance described above. For example, the k-nearest neighbor algorithm, the maximum mean discrepancy (MMD), the KL distance or the like may be used for comparison. For example, the k-nearest neighbor algorithm is characterized as being appropriately evaluable even if the data distribution is complex. The reference driving trajectory may be represented as a distribution of driving trajectories extracted from the driving trajectory model for each location (e.g., grid). The MMD is an example of a method of comparison with the distribution calculated from a reference set of driving trajectories on a location-by-location basis. The MMD may be used to determine the level of abnormality as the degree of deviation of the driving trajectory under evaluation from the distribution of reference driving trajectories extracted for each location. As compared to other measures for the distance between the distributions, the MMD is characterized by its capability of considering arbitrary distribution shapes, ease of calculation, and so on. For example, the encoding technique for driving data described in JP 2013-250663 A or the like may be adopted, the driving topic ratio described in JP 2014-235605 A or the like may be extracted for each grid, and the similarity level may be calculated using that driving topic ratio instead of the representative value.

When detecting an abnormality using the MMD, variables of the own-state quantities at each time t may be used as a feature vector (=one sample) without calculating the representative value. For example, when the variables of the self-state quantities are lat, lon, and velocity, the feature vector f(t) is expressed as follows.

f(t)=[lat(t),lon(t),velocity(t)]

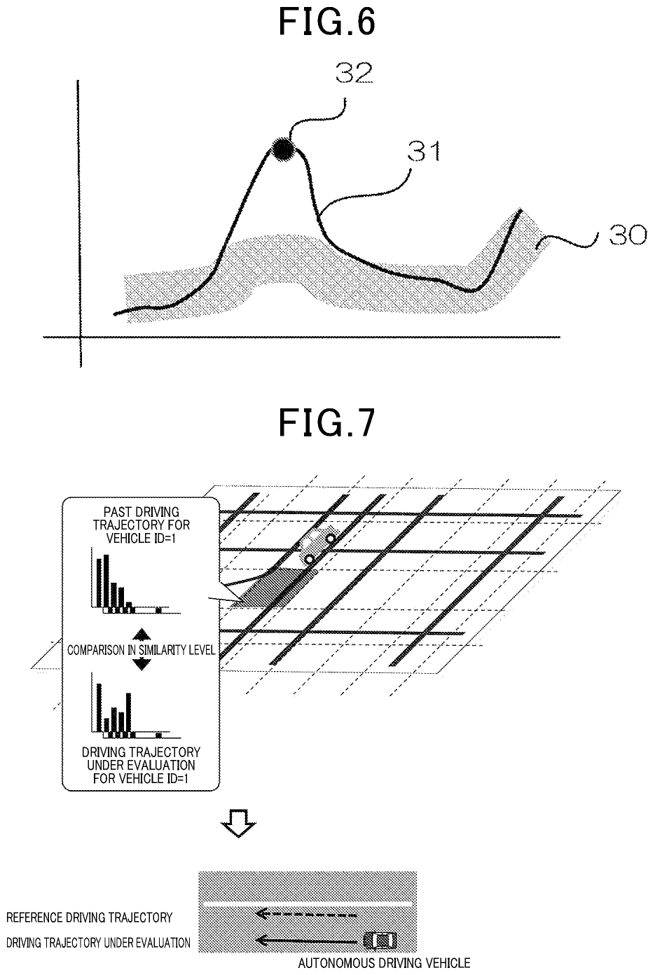

As another method, a representative value of each of the standard deviation (sigma(g)) and mean (mean(g)) of the own-state quantities in the local segment g is extracted. It is desirable to use as fine a local segment as possible for the local segment g, for example, 10 geohash digits. As an example, Vsigma(g) and Vmean(g) are the representative values for the speed. Specifically, the local segment g at time t is identified and a comparison with the representative values for the own-state quantity is made. As illustrated in FIG. 6, as an example, when the time-series data of speed is V(t) at a location where 3σ is exceeded, a determination that there is an abnormality is made when the following relationship is met.

V(t)−Vmean(g)>3Vsigma(g)

FIG. 6 is an illustration of another abnormality level determination process according to the present embodiment. In FIG. 6, the horizontal axis represents time and the vertical axis represents speed.

As illustrated in FIG. 6, the distribution 30 indicates a distribution between −1σ and +1σ, the curve 31 indicates the actual observed time series data V(t), and the point 32 indicates the point where 3σ is exceeded, i.e., the point that exceeds the threshold value.

When the abnormality level determination unit 21C determines that the abnormality level indicates the presence of an abnormality, the detailed data collection unit 21D collects image data, sensor data, and recognition results as detailed data from the on-board unit 10. Specifically, since the autonomous driving vehicle, the location, and the time when the abnormality level was determined can be identified, the on-board device 10 of the identified autonomous driving vehicle is instructed to upload the detailed data in the related grid. This eliminates the need to collect detailed data for all times, and only the detailed data at the time when the abnormality level was determined may be selectively collected.

When the abnormality level is determined by the abnormality level determination unit 21C to indicate the presence of an abnormality, the presentation unit 21E presents to the operator the image data based on which the abnormality level was determined to indicate the presence of an abnormality and receives as input from the operator the determination result including the presence or absence of an abnormality and its factor. Sensor data and recognition results may be presented to the operator in addition to the image data. The determination result may include the event that occurred. The presentation unit 21E stores in the data/model storage DB 25B, the determination result, as a label (correct answer label), including the presence or absence of an abnormality and its factor input from the operator in association with the driving data. For example, the driving data, the detailed data, the abnormality level, and the label and the like are registered in the data/model storage DB 25B.

The driving outcome output unit 21F outputs report data including the presence or absence of an abnormality and its factor which were received as input from the operator. The report data is output regularly, for example, on a daily or monthly basis. The report data may be output to, for example, a transportation operator, a developer, a road administrator or the like. The driving outcome output unit 21F is an example of an output unit.

Here, when enough data for learning is accumulated, the presence or absence of an abnormality and its factor may be inferred using artificial intelligence (AI) instead of confirmation by the operator. When the abnormality level determination unit 21C determines that the abnormality level indicates the presence of an abnormality, the learning unit 21G uses the image data, based on which the abnormality level was determined to indicate the presence of an abnormality, and artificial intelligence learned by machine learning using, as data for learning, data sets each including a confirmation of presence or absence of an abnormality and its factor that were received as input from the operator. The method of machine learning is not limited, but includes, for example, neural network, random forest, support vector machine or the like.

The inference unit 21H uses the artificial intelligence generated by the learning unit 21G to inference the presence or absence of an abnormality and its factor. In this case, the driving outcome output unit 21F outputs report data including the presence or absence of an abnormality and its factor inferred by the inference unit 21H.

When data sets are sufficiently accumulated, the presence or absence of an abnormality and its factor may be inferred using a user-defined rule base, instead of confirmation by the operator. In this case, when the abnormality level determination unit 21C determines that the abnormality level indicates the presence of an abnormality, the inference unit 21H may use the image data, based on which the abnormality level was determined to indicate the presence of an abnormality, and the rule base user-defined from data sets each including a confirmation of presence or absence of an abnormality and its factor that were received as input from the operator, thereby inferring the presence or absence of an abnormality and its factor. The driving outcome output unit 21F outputs report data including the presence or absence of an abnormality and its factor inferred by inference unit 21H in the same manner as above.

Referring to FIG. 7, the overview of the abnormality level determination process performed by the autonomous driving control device 20 of the first embodiment will now be described.

FIG. 7 is an illustration of the overall abnormality level determination process performed by the autonomous driving control device 20 according to the first embodiment.

As described above, in the present embodiment, the fact that the planner determining the driving trajectory of an autonomous driving vehicle plans the same driving trajectory in the same environment (location or section) is used.

As illustrated in FIG. 7, the reference driving trajectory acquired from the driving trajectory model (=a set of past driving trajectories) of an autonomous driving vehicle (e.g., vehicle ID=1) and the driving trajectory under evaluation of the autonomous driving vehicle (e.g., vehicle ID=1) are compared for a certain segment (e.g., grid). That is, the abnormality level, which represents the degree of deviation from the usual driving trajectory, is determined using the level of similarity. The result of the abnormality level determination may be expressed, for example, by visualizing the reference driving trajectory and the driving trajectory under evaluation in a bird's-eye view. In the example of FIG. 7, the driving trajectory under evaluation is shifted to the left of the reference driving trajectory toward the direction of travel, indicating that the vehicle is traveling more to the left than usual.

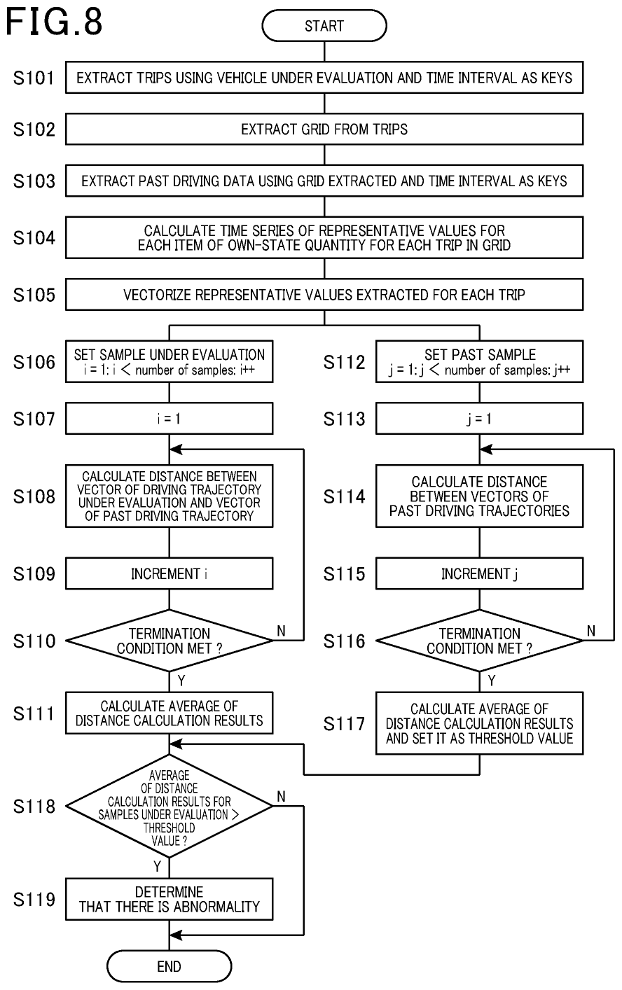

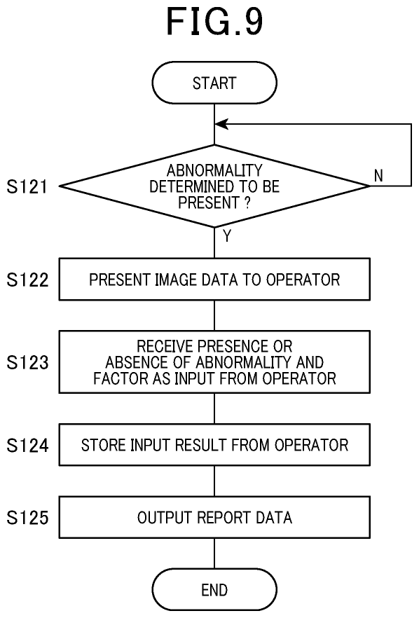

The operation of the autonomous driving control device 20 of the first embodiment will now be described with reference to FIG. 8 and FIG. 9.

FIG. 8 is a flowchart of the abnormality level determination process implemented by the autonomous driving control program 25A according to the first embodiment.

Upon the autonomous driving control device 20 being instructed to perform the abnormality level determination process, the autonomous driving control program 25A is initiated and each of the following steps is performed.

At step S101 in FIG. 8, the CPU 21 extracts trips using the vehicle under evaluation and the time interval (e.g., one to seven days ago) as keys. One trip is, for example, a series of runs from ignition ON to ignition OFF for one vehicle.

At step S102, the CPU 21 extracts a grid (location or segment) from the trips extracted at step S101. For the grid, a geohash may be used as described above.

At step S23, the CPU 21 extracts past driving data using the grid extracted at step S102 and the time interval as keys. The past driving data includes the own-state quantities of the autonomous driving vehicle. As described above, as an example, the own-state quantities include vehicle behaviors, such as accelerating operation, steering operation, braking operation, an acceleration, a speed, a yaw rate, latitude and longitude (location information), time information, a vehicle angle, a target speed, a planning result, and the like.

At step S104, the CPU 21 calculates a time series of representative values for each item of own-state quantity for each trip in the grid. As described above, as an example, the mean, variance, maximum value, minimum value, etc. are used for the representative values.

At step S105, the CPU 21 vectorizes the time-series data of representative values of own-state quantities extracted for each trip. This generates a vector (feature quantities) representing the driving trajectory. The vector extracted for each trip is one sample.

At step S106, the CPU 21 sets the sample under evaluation (i=1; i<the number of samples; i++).

At step S107, the CPU 21 sets i=1 for the sample under evaluation.

At step S108, the CPU 21 calculates a distance between the vector of the driving trajectory under evaluation and the vector of the past driving trajectory.

At step S109, the CPU 21 increments i for the sample under evaluation.

At step S110, the CPU 21 determines whether the termination condition (i=I (I: the number of target samples)) is met. If the termination condition is determined to be met (the answer is YES), the process proceeds to step S111. If the termination condition is determined not to be met (the answer is NO), the process returns to step S108 and repeats the process.

At step S111, the CPU 21 calculates the average of the distance calculation results for the samples under evaluation.

On the other hand, at step S112, the CPU 21 sets the past sample (j=1; j<the number of samples; j++).

At step S113, the CPU 21 sets j=1 for the past sample.

At step S114, the CPU 21 calculates the distance between the vectors of the past driving trajectories.

At step S115, the CPU 21 increments j for the past sample.

At step S116, the CPU 21 determines whether the termination condition (j=J (J: the number of target samples)) is met. If it is determined that the termination condition is met (the answer is YES), the process proceeds to step S117, and if it is determined that the termination condition is not met (the answer is NO), the process returns to step S114 and repeats the process.

At step S117, the CPU 21 calculates the average of the distance calculation results and sets it as a threshold value.

At step S118, the CPU 21 determines whether the average of the distance calculation results for the samples under evaluation, calculated at step S111, is greater than the threshold value calculated at step S117. If it is determined that the average of the distance calculation results for the samples under evaluation is greater than the threshold value (the answer is YES), the process proceeds to step S119, and if it is determined that the average of the distance calculation results for the samples under evaluation is less than or equal to the threshold value (the answer is NO), the abnormality level determination process implemented by the autonomous driving control program 25A is completed.

At step S119, the CPU 21 determines that the determination result at step S118 indicates the presence of an abnormality, and the abnormality level determination process implemented by the autonomous driving control program 25A is terminated.

FIG. 9 is an example of a flowchart of the report output process implemented by the autonomous driving control program 25A according to the first embodiment. Upon the autonomous driving control device 20 being instructed to perform the report output process, the autonomous driving control program 25A is initiated and each of the following steps is performed. The report output process may be performed continuously from the abnormality level determination process described in FIG. 8.

At step S121 in FIG. 9, the CPU 21 determines whether the result of the abnormality level determination process described in FIG. 8 above indicates the presence of an abnormality. If the result of the abnormality level determination process indicates the presence of an abnormality (the answer is YES), the process proceeds to step S122, and if the result of the abnormality level determination process indicates the absence of an abnormality (the answer is NO), the process waits at step S121.

At step S122, the CPU 21 collects detailed data including image data, sensor data, and recognition results from the autonomous driving vehicle that is determined to be abnormal, and presents the collected detailed data to the operator.

At step S123, the CPU 21 receives as input from the operator the determination result including the presence or absence of an abnormality and its factor. If enough data for learning has been accumulated, the presence or absence of an abnormality and its factor may be inferred using the artificial intelligence described above, or if enough data sets have been accumulated, the presence or absence of an abnormality and its factor may be inferred using the rule base described above.

At step S124, the CPU 21 stores the input result including the presence or absence of an abnormality and its factor that were received as input from the operator at step S123, in the data/model storage DB 25B.

At step S125, the CPU 21 outputs report data including the presence or absence of an abnormality and its factor that were received as input from the operator, and the report output process implemented by the autonomous driving control program 25A is terminated. The report data is output regularly, for example, on a daily or monthly basis. The report data is output to, for example, a transportation operator, a developer, or a road administrator.

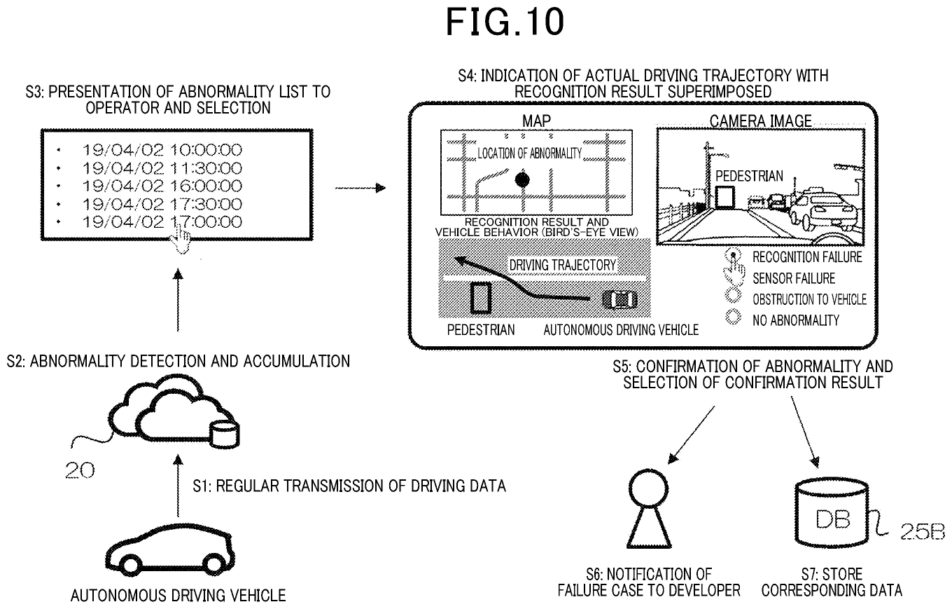

Next, with reference to FIGS. 10 to 12, the process of the operator determining the presence or absence of an abnormality and its factor (hereinafter referred to as the “determination-by-operator process”) will be described in detail.

FIG. 10 is an illustration of the determination-by-operator process according to the present embodiment.

At step S1, the autonomous driving vehicle regularly transmits driving data to the autonomous driving control device 20 of the autonomous driving assistance center.

At step S2, the CPU 21 of the autonomous driving control device 20 detects an abnormality in the driving trajectory based on the driving data from the autonomous driving vehicle, and stores a detection result in the data/model storage DB 25B.

At step S3, the CPU 21 of the autonomous driving control device 20 presents a list of a plurality of pieces of abnormality data to the operator, and receives a selection of the abnormality data from the operator.

At step S4, the CPU 21 of the autonomous driving control device 20 performs control to display to the operator the actual driving trajectory with the recognition result superimposed for the abnormality data selected by the operator at step S3. In other words, since it is difficult to confirm all the recognition results, the operator may confirm the recognition result by focusing on the scene where there is an abnormality in the driving trajectory.

At step S5, the CPU 21 of the autonomous driving control device 20 receives a confirmation of the abnormality and a selection of the result of confirmation from the operator.

At step S6, the CPU 21 of the autonomous driving control device 20 notifies a developer of the failure case.

At step S7, the CPU 21 of the autonomous driving control device 20 stores the corresponding data in the data/model storage DB 25B.

As illustrated in FIG. 10, the on-board camera image (image data) with the recognition result superimposed is displayed as the collected detailed data to thereby detect various abnormalities. For example, if a pedestrian is recognized as being present despite the fact that no pedestrian is rushing out in the image, it can be determined at that time that the driving trajectory is arising from a false positive by the recognition program. Although it is difficult to confirm all the recognition results of the autonomous driving vehicle, it is possible to detect critical false positives, non-detections, or sensor failures by focusing on a scene in which there is an abnormality in the behavior.

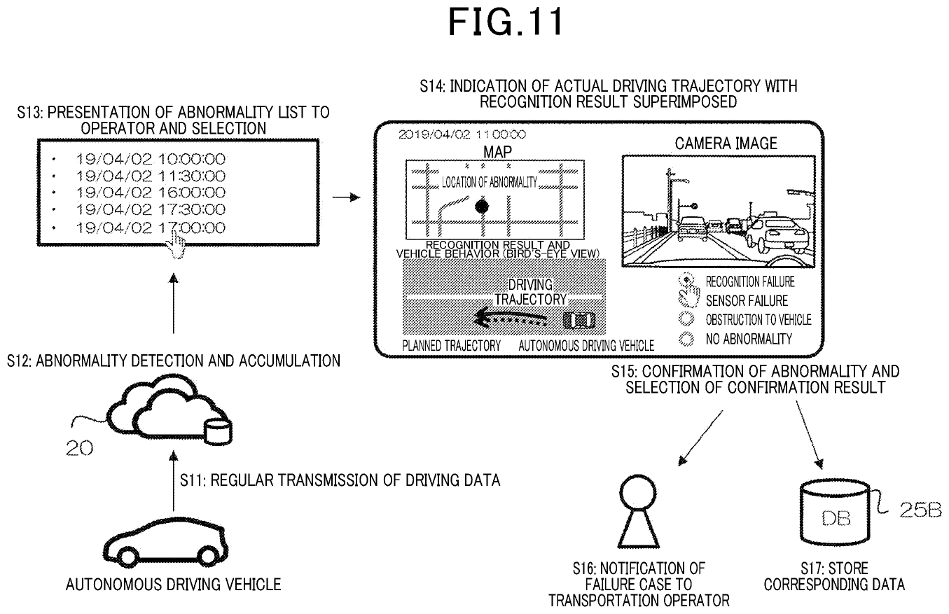

FIG. 11 is an illustration of another determination-by-operator process according to the present embodiment.

At step S11, the autonomous driving vehicle regularly transmits driving data to the autonomous driving control device 20 of the autonomous driving assistance center.

At step S12, the CPU 21 of the autonomous driving control device 20 detects an abnormality in the driving trajectory based on the driving data from the autonomous driving vehicle, and stores a detection result in the data/model storage DB 25B.

At step S13, the CPU 21 of the autonomous driving control device 20 presents a list of a plurality of pieces of abnormality data to the operator, and receives a selection of the abnormality data from the operator.

At step S14, the CPU 21 of the autonomous driving control device 20 performs control to display to the operator the actual driving trajectory with the recognition result superimposed for the abnormality data selected by the operator at step S13. In other words, since it is difficult to confirm all the recognition results, the operator is allowed to confirm the recognition result by focusing on the scene where there is an abnormality in the driving trajectory.

At step S15, the CPU 21 of the autonomous driving control device 20 receives a confirmation of the abnormality and a selection of the result of confirmation from the operator.

At step S16, the CPU 21 of the autonomous driving control device 20 notifies a developer of the failure case.

At step S17, the CPU 21 of the autonomous driving control device 20 stores the corresponding data in the data/model storage DB 25B.

As illustrated in FIG. 11, the actual driving trajectory and the planned trajectory are superimposed and displayed, which makes it possible to detect a suspected failure of the autonomous driving vehicle itself. For example, if the tires are punctured, the actual driving trajectory may fail to follow the planned trajectory correctly.

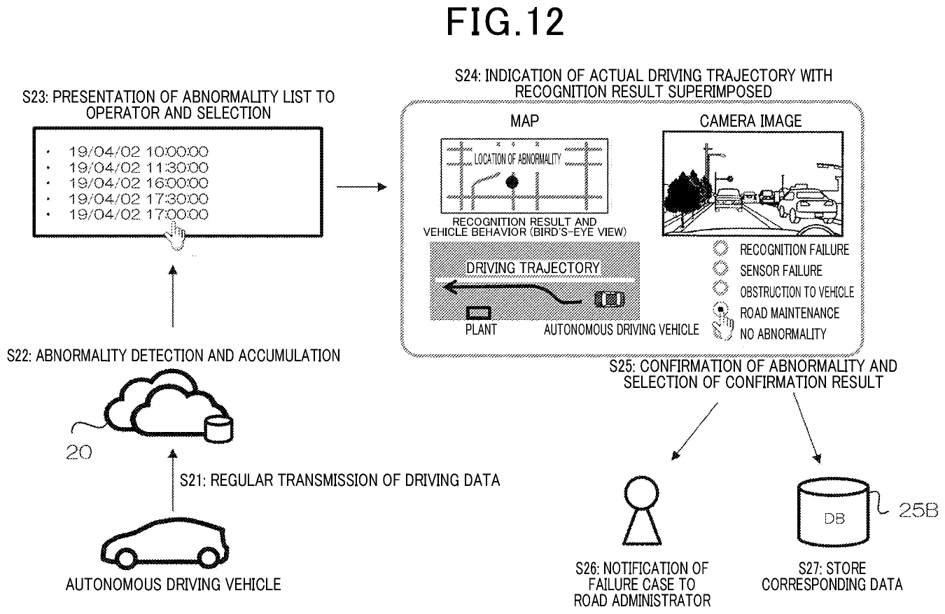

FIG. 12 is an illustration of yet another determination-by-operator process according to the present embodiment.

At step S21, the autonomous driving vehicle regularly transmits driving data to the autonomous driving control device 20 of the driving assistance center.

At step S22, the CPU 21 of the autonomous driving control device 20 detects an abnormality in the driving trajectory based on the driving data from the autonomous driving vehicle, and stores a detection result in the data/model storage DB 25B.

At step S23, the CPU 21 of the autonomous driving control device 20 presents a list of a plurality of pieces of abnormality data to the operator, and receives a selection of the abnormality data from the operator.

At step S24, the CPU 21 of the autonomous driving control device 20 performs control to display to the operator the actual driving trajectory with the recognition result superimposed for the abnormality data selected by the operator at step S23. In other words, since it is difficult to confirm all the recognition results, the operator is allowed to confirm the recognition result by focusing on the scene where there is an abnormality in the driving trajectory.

At step S25, the CPU 21 of the autonomous driving control device 20 receives a confirmation of the abnormality and a selection of the result of confirmation from the operator.

At step S26, the CPU 21 of the autonomous driving control device 20 notifies a developer of the failure case.

At step S27, the CPU 21 of the autonomous driving control device 20 stores the corresponding data in the data/model storage DB 25B.

As illustrated in FIG. 12, displaying the recognition result and the driving trajectory together with the camera image as a bird's-eye view allows the driving trajectory affected by an unexpected target to be extracted. In the example of FIG. 12, it can be understood by looking at a camera image with a superimposed result that the vehicle cannot travel in the center of the lane due to trees overhanging on the roadside strip.

As described above, according to the present embodiment, the abnormality level, which is expressed as a degree of deviation between the reference driving trajectory and the driving trajectory under evaluation, is determined. In this way, driving that is not an obvious abnormality in autonomous driving but deviates from planned or optimal driving is determined.

A report including the presence or absence of an abnormality and its factor is provided to the developer and other related parties, which may improve the failure case that was not noticed by the autonomous driving vehicle itself.

Even in the absence of a failure, a scene in which unusual and complex driving maneuvers (e.g., emergency avoidance of a rushing out pedestrian, or the like) are required can be detected, and evidence can be shown that the environment is recognized appropriately and driving is being performed with appropriate margins.

### Second Embodiment

In the first embodiment described above, the abnormality level, which is expressed as a degree of deviation between the reference driving trajectory and the driving trajectory under evaluation, has been described. In a second embodiment, the abnormality level expressed as the degree of deviation between the reference driving trajectory and the driving trajectory under evaluation is determined, and furthermore, a learner is applied to the driving trajectory whose abnormality level indicates the presence of an abnormality to thereby determine the presence of a significant abnormality.

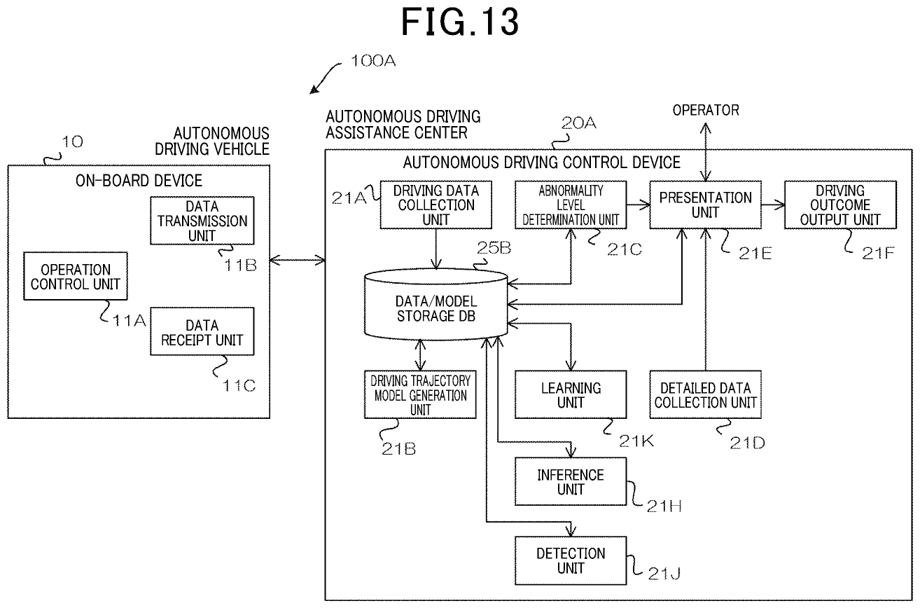

FIG. 13 is a block diagram illustrating an example of the functional configuration of the on-board device 10 and the autonomous driving control device according to the second embodiment. The autonomous driving control device 20A and the on-board device 10 form the autonomous driving system 100A.

The CPU 21 of the autonomous driving control device 20A according to the present embodiment serves as the respective functional blocks illustrated in FIG. 13 by writing and executing the autonomous driving control program 25A, which is stored in the storage unit 25, into the RAM. The CPU 11 of the on-board device 10 according to the present embodiment serves as the respective functional blocks illustrated in FIG. 13 by writing and executing the control program, which is stored in the storage unit 14, into the RAM.

As illustrated in FIG. 13, the CPU 21 of the autonomous driving control device 20A according to the present embodiment serves as the driving data collection unit 21A, the driving trajectory model generation unit 21B, the abnormality level determination unit 21C, the detailed data collection unit 21D, the presentation unit 21E, the driving outcome output unit 21F, the inference unit 21H, a detection unit 21J, and a learning unit 21K. In the autonomous driving control device 20A according to the present embodiment, the same or equivalent parts as those described in the first embodiment are assigned with the same reference numerals in the drawings, and the same description is adopted for parts with the same reference numerals.

The CPU 11 of the on-board device 10 according to the present embodiment serves as the operation control unit 11A, the data transmission unit 11B, and the data receipt unit 11C. In the on-board device 10 according to the present embodiment, the same or equivalent parts as those described in the first embodiment are assigned with the same reference numerals in the drawings, and the same description is adopted for parts with the same reference numerals.

When the abnormality level is determined by the abnormality level determination unit 21C to indicate the presence of an abnormality, the operator presentation unit 21E presents to the operator the image data based on which the abnormality level was determined to indicate the presence of an abnormality and receives as input from the operator the presence or absence of an abnormality and its factor. In this case, the learning unit 21K generates a learner by machine learning the classification of driving trajectory under evaluation, using the factor received as input from the operator as a label. Specifically, based on the detailed data, driving data, and labels stored in the data/model storage DB 25B, a learner is generated to identify significant abnormalities (e.g., vehicle obstructions, etc.).

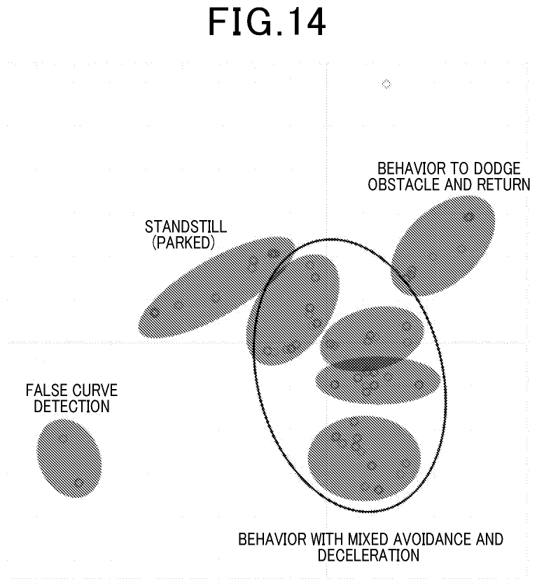

FIG. 14 is an illustration of a clustering process according to the present embodiment.

In the example of FIG. 14, the feature quantities representing the own-state quantities of each driving trajectory under evaluation in the abnormality level determination process are mapped, visualized, and clustered in two dimensions. As can be seen therefrom, a specific behavior appears as a cluster. In the learning unit 21K, a learner is generated using a set of feature quantities that represent the own-state quantities of each driving trajectory under evaluation, events that have occurred, and their factor labels. For machine learning of the learner, a neural network, for example, may be used. This enables classification of feature quantities representing own-state quantities included in the driving data.

The detection unit 21J uses the learner generated by the learning unit 21K to detect a significant abnormality indicated as the factor. That is, driving trajectories, which exhibit abnormalities in the abnormality level determination process described in the first embodiment above, are filtered. Thereafter, the learner is applied by focusing on driving trajectories that exhibit abnormalities. In addition, whether an immediate notification to the operator is needed is registered in advance to the labels under determination by the learner. This makes it possible to immediately notify and alert the operator when a driving trajectory with the label having the need for an immediate notification registered is identified. This configuration also eliminates the need for the operator's determination and enables automatic estimation of abnormality factors.

When the abnormality level determination unit 21C determines that the abnormality level indicates the presence of an abnormality, the inference unit 21H may use the image data, based on which the abnormality level was determined to indicate the presence of an abnormality, and artificial intelligence learned through machine learning using, as data for learning, data sets each including a confirmation of presence or absence of an abnormality and its factor that were received as input from the operator, thereby inferring the presence or absence of an abnormality and its factor. In this case, with the factors inferred by the inference unit 21H as labels, the detection unit 21J detects a significant abnormality indicated as a factor, using the learner generated by machine learning classification of the driving trajectory under evaluation.

When the abnormality level determination unit 21C determines that the abnormality level indicates the presence of an abnormality, the inference unit 21H may use the image data, based on which the abnormality level was determined to indicate the presence of an abnormality, and the rule base user-defined from data sets each including a confirmation of presence or absence of an abnormality and its factor that were received as input from the operator, thereby inferring the presence or absence of an abnormality and its factor. In this case, with the factors inferred by the inference unit 21H as labels, the detection unit 21J detects a significant abnormality indicated as a factor, using the learner generated by machine learning classification of the driving trajectory under evaluation. Specifically, the learner is used to classify the feature quantities representing the own-state quantities of each driving trajectory under evaluation, and the significant abnormality indicated as a factor corresponding to the classification is detected, as illustrated in FIG. 14 above.

Here, when a specific abnormal event is detected by the detection unit 21J, the detailed data collection unit 21D requests the autonomous driving vehicle to transmit the compressed camera image so as to allow the operator to confirm the camera image. This allows immediate confirmation of contradistinction between the recognition result and the camera image.

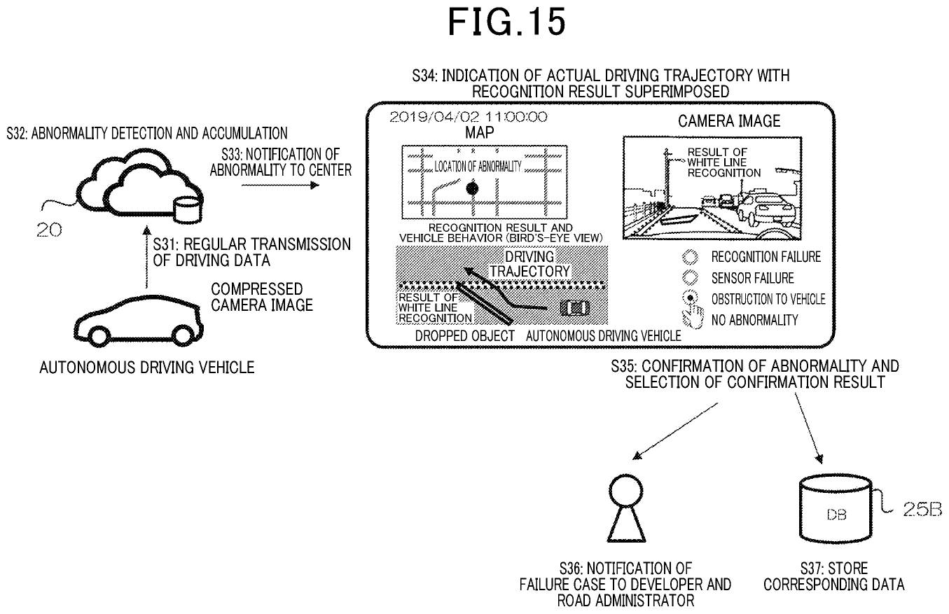

As illustrated in FIG. 15, as an example, the presentation unit 21E presents to the operator the specific abnormal event detected by the detection unit 21J and the camera image collected by the detailed data collection unit 21D.

FIG. 15 is an illustration of the determination-by-operator process according to the present embodiment.

At step S31, the autonomous driving vehicle regularly transmits driving data to the autonomous driving control device 20A of the driving assistance center. Upon the autonomous driving control device 20A detecting an abnormality, the autonomous driving vehicle transmits a compressed camera image in response to a request from the autonomous driving control device 20A.

At step S32, the CPU 21 of the autonomous driving control device 20A detects an abnormality in the driving trajectory based on the driving data from the autonomous driving vehicle, and stores a detection result in the data/model storage DB 25B.

At step S33, the CPU 21 of the autonomous driving control device 20A notifies the operator of the autonomous driving assistance center of the abnormality together with the camera image.

At step S34, the CPU 21 of the autonomous driving control device 20A performs control to display to the operator the actual driving trajectory with the recognition result superimposed for the abnormality notified at step S33.

At step S35, the CPU 21 of the autonomous driving control device 20A receives a confirmation of the abnormality and a selection of the result of confirmation from the operator.

At step S36, the CPU 21 of the autonomous driving control device 20A notifies a developer and a road administrator of the failure case.

At step S37, the CPU 21 of the autonomous driving control device 20A stores the corresponding data in the data/model storage DB 25B.

As illustrated in FIG. 15, the operator can determine what abnormality is currently occurring by confirming the actual driving trajectory, the recognition result, and the camera image. This enables detection and response to significant events that may affect driving, such as hacking or vehicle obstruction or the like.

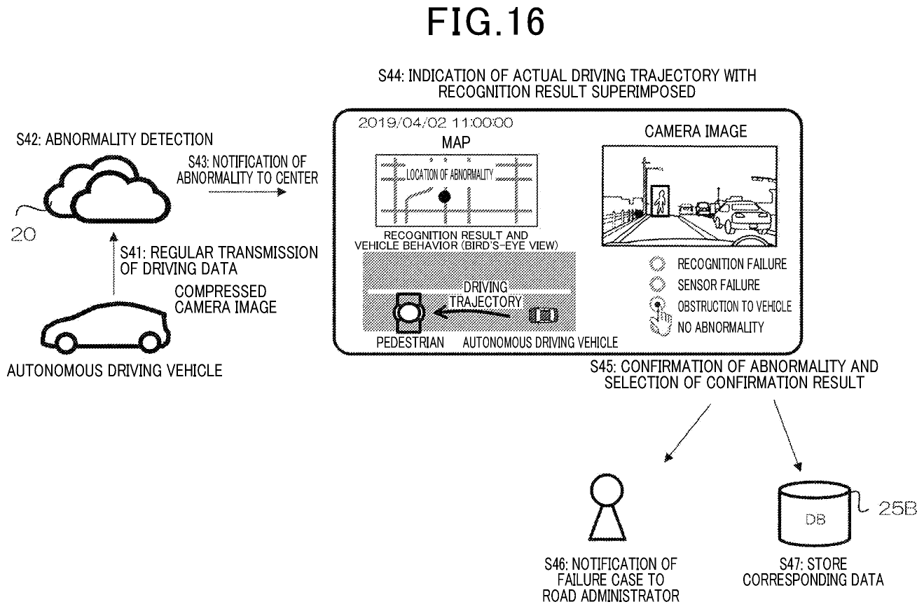

FIG. 16 is an illustration of another determination-by-operator process according to the present embodiment.

At step S41, the autonomous driving vehicle regularly transmits driving data to the autonomous driving control device 20A of the driving assistance center. Upon the autonomous driving control device 20A detecting an abnormality, the autonomous driving vehicle transmits a compressed camera image in response to a request from the autonomous driving control device 20A.

At step S42, the CPU 21 of the autonomous driving control device 20A detects an abnormality in the driving trajectory based on the driving data from the autonomous driving vehicle.

At step S43, the CPU 21 of the autonomous driving control device 20A notifies the operator of the autonomous driving assistance center of the abnormality.

At step S44, the CPU 21 of the autonomous driving control device 20A performs control to display to the operator the actual driving trajectory with the recognition result superimposed for the abnormality notified at step S43.

At step S45, the CPU 21 of the autonomous driving control device 20A receives a confirmation of the abnormality and a selection of the result of confirmation from the operator.

At step S46, the CPU 21 of the autonomous driving control device 20A notifies a road administrator of the failure case.

At step S47, the CPU 21 of the autonomous driving control device 20A stores the corresponding data in the data/model storage DB 25B.

As illustrated in FIG. 16, an event that is determined by the operator to be a significant abnormality is immediately notified to the developer, road service provider, police or the like. In the example of FIG. 16, the vehicle slowed down in response to recognizing a vehicle obstruction, e.g., a pedestrian, but the vehicle obstruction was not actually a pedestrian (e.g., it was actually a dropped object, such as a mannequin).

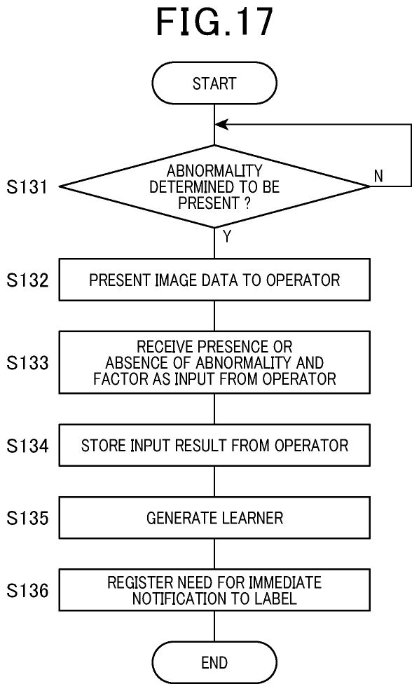

FIG. 17 is an example of a flowchart of a learner generation process implemented by the autonomous driving control program 25A according to the second embodiment.

Upon the autonomous driving control device 20A being instructed to perform the learner generation process, the autonomous driving control program 25A is initiated and each of the following steps is performed. The learner generation process may be performed continuously from the abnormality level determination process described in FIG. 8.

At step S131 in FIG. 17, the CPU 21 determines whether the determination result of the abnormality level determination process described above in FIG. 8 indicates the presence an abnormality. If the answer is YES at step S131, the process proceeds to step S132. If the answer is NO at step S131, the process waits at step S131.

At step S132, the CPU 21 collects detailed data including image data, sensor data, and recognition results from the autonomous driving vehicle that has been determined to be abnormal, and presents the collected detailed data to the operator.

At step S133, the CPU 21 receives as input from the operator the determination result including the presence or absence of an abnormality and its factor. If enough data for learning has been accumulated, the presence or absence of an abnormality and its factor may be inferred using the artificial intelligence described above, or if enough data sets have been accumulated, the presence or absence of an abnormality and its factor may be inferred using the rule base described above.

At step S134, the CPU 21 stores the input result including the presence or absence of an abnormality and its factor that were received as input from the operator at step S133, in the data/model storage DB 25B.

At step S135, the CPU 21 generates a learner by machine learning the classification of the driving trajectory under evaluation, using the factor received as input from the operator as a label. Specifically, based on the detailed data, driving data, and labels stored in the data/model storage DB 25B, a learner is generated to identify significant abnormalities.

At step S136, the CPU 21 registers the need for immediate notification to the labels for the learner and terminates the learner generation process by the autonomous driving control program 25A.

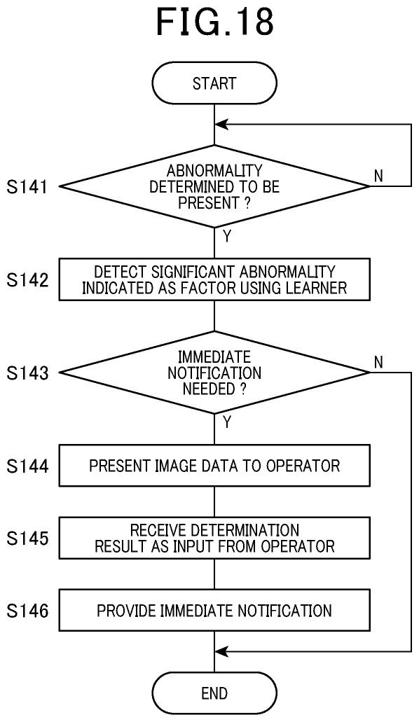

FIG. 18 is an example of a flowchart of an immediate notification process implemented by the autonomous driving control program 25A according to the second embodiment.

Upon the autonomous driving control device 20A being instructed to perform the immediate notification process, the autonomous driving control program 25A is initiated and each of the following steps is performed.

At step S141 in FIG. 18, the CPU 21 determines whether the determination result of the abnormality level determination process described above in FIG. 8 indicates the presence of an abnormality. If the answer is YES at step S141, the process proceeds to step S142. If the answer is NO at step S141, the process waits at step S141.

At step S142, the CPU 21 uses the learner to classify the feature quantities representing the own-state quantities of each driving trajectory under evaluation, and detects a significant abnormality indicated as a factor corresponding to the classification.

At step S143, the CPU 21 determines whether an immediate notification is needed for the above factor. If it is determined that an immediate notification is needed (the answer is YES), the process proceeds to step S144. If it is determined that an immediate notification is not needed (the answer is NO), the immediate notification process by the autonomous driving control program 25A is terminated.

At step S144, the CPU 21 collects detailed data including image data, sensor data, and recognition results from the autonomous driving vehicle that has been determined to be abnormal, and presents the collected detailed data to the operator.

At step S145, the CPU 21 receives the determination result as input from the operator.

At step S146, the CPU 21 immediately notifies the developer, road service provider, police or the like, according to the determination result from the operator, and terminates the immediate notification process by the autonomous driving control program 25A.

As described above, according to the present embodiment, the abnormality level, represented as a degree of deviation between the reference driving trajectory and the driving trajectory under evaluation, is determined, and furthermore, the learner is applied to the driving trajectory under evaluation for which the abnormality level is determined to indicate the presence of an abnormality. When a significant abnormality is detected using the learner, the developer, road service provider or the like may be immediately notified.

As described above, the autonomous driving control device according to each of the above embodiments has been described by way of example. The embodiment may also be in the form of programs for causing a computer to execute the functions of the various parts provided in the autonomous driving control device. The embodiment may also be in the form of a computer-readable non-transitory storage medium storing these programs.

The configuration of the autonomous driving control device described in each of the above embodiments is a specific example, and may be modified according to a situation without departing from the gist of the present disclosure.

The process flows of the programs described in the above embodiments are examples. In these process flows, unnecessary steps may be deleted, new steps may be added, or the order of steps may be changed, without departing from the gist of the present disclosure.

In the above embodiments, the processes according to the embodiments have been described by being implemented by a software configuration using a computer executing the program, but the above embodiments are not limited to such a software configuration. These embodiments may, for example, be implemented by a hardware configuration or a combination of a hardware configuration and a software configuration.

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

What is claimed is:

1. An autonomous driving control device comprising:
a collection unit configured to collect from an autonomous driving vehicle having a driving trajectory planned in advance, driving data including own-state quantities representing a state of the autonomous driving vehicle;
a generation unit configured to generate a driving trajectory model representing specific values of the own-state quantities in a time series based on the driving data collected by the collection unit;
a determination unit configured to compare a driving trajectory under evaluation for the autonomous driving vehicle with a reference driving trajectory acquired from the driving trajectory model generated by the generation unit, and determine an abnormality level indicating a degree of deviation between the driving trajectory under evaluation and the reference driving trajectory;
a presentation unit configured to, upon the determination unit determining that the abnormality level indicates presence of an abnormality, present to an operator image data, based on which the abnormality level was determined to indicate the presence of an abnormality, and receive a confirmation of presence or absence of an abnormality and its factor as input from the operator; and
an output unit configured to output report data including the confirmation of presence or absence of an abnormality and its factor that are received as input from the operator.

2. The autonomous driving control device according to claim 1, wherein
the abnormality level is a level of similarity between the reference driving trajectory and the driving trajectory under evaluation.

3. The autonomous driving control device according to claim 2, wherein
the reference driving trajectory is expressed as a distribution of driving trajectories extracted from the driving trajectory model for each location.

4. The autonomous driving control device according to claim 1, wherein
the generation unit is configured to calculate, as the specific values of own-state quantities, offset values representing time series deviations of a candidate driving trajectory or actual driving trajectory from the reference trajectory planned in advance on a map, and then aggregate the calculated offset values within a predetermined region, thereby calculating a representative value of the own-state quantities.

5. The autonomous driving control device according to claim 1, wherein
the generation unit is configured to generate the driving trajectory model for each autonomous driving vehicle.

6. The autonomous driving control device according to claim 1, wherein
the generation unit is configured to generate the driving trajectory model for each version of a program for controlling autonomous driving of the autonomous driving vehicle.

7. An autonomous driving control device comprising:
a collection unit configured to collect from an autonomous driving vehicle having a driving trajectory planned in advance, driving data including own-state quantities representing a state of the autonomous driving vehicle;
a generation unit configured to generate a driving trajectory model representing specific values of the own-state quantities in a time series based on the driving data collected by the collection unit;
a determination unit configured to compare a driving trajectory under evaluation for the autonomous driving vehicle with a reference driving trajectory acquired from the driving trajectory model generated by the generation unit, and determine an abnormality level indicating a degree of deviation between the driving trajectory under evaluation and the reference driving trajectory;
an inference unit configured to, upon the determination unit determining that the abnormality level indicates presence of an abnormality, use image data, based on which the abnormality level was determined to indicate the presence of an abnormality, and artificial intelligence learned through machine learning using, as data for learning, data sets each including a confirmation of presence or absence of an abnormality and its factor that were received as input from an operator, thereby inferring the presence or absence of an abnormality and its factor; and
an output unit configured to output report data including the presence or absence of an abnormality and its factor inferred by the inference unit.

8. The autonomous driving control device according to claim 7, wherein
the abnormality level is a level of similarity between the reference driving trajectory and the driving trajectory under evaluation.

9. The autonomous driving control device according to claim 8, wherein
the reference driving trajectory is expressed as a distribution of driving trajectories extracted from the driving trajectory model for each location.

10. The autonomous driving control device according to claim 7, wherein
the generation unit is configured to calculate, as the specific values of own-state quantities, offset values representing time series deviations of a candidate driving trajectory or actual driving trajectory from the reference trajectory planned in advance on a map, and then aggregate the calculated offset values within a predetermined region, thereby calculating a representative value of the own-state quantities.

11. The autonomous driving control device according to claim 7, wherein
the generation unit is configured to generate the driving trajectory model for each autonomous driving vehicle.

12. The autonomous driving control device according to claim 7, wherein
the generation unit is configured to generate the driving trajectory model for each version of a program for controlling autonomous driving of the autonomous driving vehicle.

13. An autonomous driving control device comprising:
a collection unit configured to collect from an autonomous driving vehicle having a driving trajectory planned in advance, driving data including own-state quantities representing a state of the autonomous driving vehicle;
a generation unit configured to generate a driving trajectory model representing specific values of the own-state quantities in a time series based on the driving data collected by the collection unit;
a determination unit configured to compare a driving trajectory under evaluation for the autonomous driving vehicle with a reference driving trajectory acquired from the driving trajectory model generated by the generation unit, and determine an abnormality level indicating a degree of deviation between the driving trajectory under evaluation and the reference driving trajectory;
an inference unit configured to, upon the determination unit determining that the abnormality level indicates presence of an abnormality, use image data, based on which the abnormality level was determined to indicate the presence of an abnormality, and a rule base user-defined from data sets each including a confirmation of presence or absence of an abnormality and its factor that were received as input from an operator, thereby inferring the presence or absence of an abnormality and its factor; and
an output unit configured to output report data including the presence or absence of an abnormality and its factor inferred by the inference unit.

14. An autonomous driving control device comprising:
a collection unit configured to collect from an autonomous driving vehicle having a driving trajectory planned in advance, driving data including own-state quantities representing a state of the autonomous driving vehicle;
a generation unit configured to generate a driving trajectory model representing specific values of the own-state quantities in a time series based on the driving data collected by the collection unit;
a determination unit configured to compare a driving trajectory under evaluation for the autonomous driving vehicle with a reference driving trajectory acquired from the driving trajectory model generated by the generation unit, and determine an abnormality level indicating a degree of deviation between the driving trajectory under evaluation and the reference driving trajectory;
an inference unit configured to, upon the determination unit determining that the abnormality level indicates presence of an abnormality, present to an operator image data, based on which the abnormality level was determined to indicate the presence of an abnormality, and receive as input from the operator a confirmation of presence or absence of an abnormality and its factor; and
a detection unit configured to, with the factor received as input from the operator as a label, detect a significant abnormality indicated as the factor, using a learner generated by machine learning classification of the driving trajectory under evaluation.

15. An autonomous driving control device comprising:
a collection unit configured to collect from an autonomous driving vehicle having a driving trajectory planned in advance, driving data including own-state quantities representing a state of the autonomous driving vehicle; a generation unit configured to generate a driving trajectory model representing specific values of the own-state quantities in a time series based on the driving data collected by the collection unit;
a determination unit configured to compare a driving trajectory under evaluation for the autonomous driving vehicle with a reference driving trajectory acquired from the driving trajectory model generated by the generation unit, and determine an abnormality level indicating a degree of deviation between the driving trajectory under evaluation and the reference driving trajectory;
an inference unit configured to, upon the determination unit determining that the abnormality level indicates presence of an abnormality, use image data, based on which the abnormality level was determined to indicate the presence of an abnormality, and artificial intelligence learned through machine learning using, as data for learning, data sets each including a confirmation of presence or absence of an abnormality and its factor that were received as input from an operator, thereby inferring the presence or absence of an abnormality and its factor; and
a detection unit configured to, with the factor inferred by the inference unit as a label, detect a significant abnormality indicated as the factor, using a learner generated by machine learning classification of the driving trajectory under evaluation.

16. An autonomous driving control device comprising:
a collection unit configured to collect from an autonomous driving vehicle having a driving trajectory planned in advance, driving data including own-state quantities representing a state of the autonomous driving vehicle;
a generation unit configured to generate a driving trajectory model representing specific values of the own-state quantities in a time series based on the driving data collected by the collection unit;
a determination unit configured to compare a driving trajectory under evaluation for the autonomous driving vehicle with a reference driving trajectory acquired from the driving trajectory model generated by the generation unit, and determine an abnormality level indicating a degree of deviation between the driving trajectory under evaluation and the reference driving trajectory;
an inference unit configured to, upon the determination unit determining that the abnormality level indicates presence of an abnormality, use image data, based on which the abnormality level was determined to indicate the presence of an abnormality, and a rule base user-defined from data sets each including a confirmation of presence or absence of an abnormality and its factor that were received as input from an operator, thereby inferring the presence or absence of an abnormality and its factor; and
a detection unit configured to, with the factor inferred by the inference unit as a label, detect a significant abnormality indicated as the factor, using a learner generated by machine learning classification of the driving trajectory under evaluation.

17. An autonomous driving control method comprising:
collecting from an autonomous driving vehicle having a driving trajectory planned in advance, driving data including own-state quantities representing a state of the autonomous driving vehicle;
generating a driving trajectory model representing specific values of the own-state quantities in a time series based on the collected driving data;
comparing a driving trajectory under evaluation for the autonomous driving vehicle with a reference driving trajectory acquired from the generated driving trajectory model, and determining an abnormality level indicating a degree of deviation between the driving trajectory under evaluation and the reference driving trajectory;
upon determining that the abnormality level indicates presence of an abnormality, presenting to an operator image data, based on which the abnormality level was determined to indicate the presence of an abnormality, and receiving a confirmation of presence or absence of an abnormality and its factor as input from the operator; and
outputting report data including the confirmation of presence or absence of an abnormality and its factor that are received as input from the operator.

18. A non-transitory computer readable medium having stored thereon instructions executable by a computer to cause the computer to perform an autonomous driving control method, comprising:
collecting from an autonomous driving vehicle having a driving trajectory planned in advance, driving data including own-state quantities representing a state of the autonomous driving vehicle;
generating a driving trajectory model representing specific values of the own-state quantities in a time series based on the collected driving data;
comparing a driving trajectory under evaluation for the autonomous driving vehicle with a reference driving trajectory acquired from the generated driving trajectory model, and determining an abnormality level indicating a degree of deviation between the driving trajectory under evaluation and the reference driving trajectory;
upon determining that the abnormality level indicates presence of an abnormality, presenting to an operator image data, based on which the abnormality level was determined to indicate the presence of an abnormality, and receiving a confirmation of presence or absence of an abnormality and its factor as input from the operator; and
outputting report data including the confirmation of presence or absence of an abnormality and its factor that are received as input from the operator.
